(19) United States
(12) Patent Application Publication
(10) Pub. No.: US 2025/0055181 A1
(43) Pub. Date: Feb. 13, 2025

(54) PATCH ANTENNA AND ANTENNA DEVICE

(71) Applicant: YOKOWO CO., LTD., Tokyo (JP)

(72) Inventors: Yuki TAKAYAMA, Gunma (JP); Satoshi IWASAKI, Gunma (JP); Noritaka TERASHITA, Gunma (JP)

(73) Assignee: YOKOWO CO., LTD., Tokyo (JP)

(21) Appl. No.: 18/723,468

(22) PCT Filed: Dec. 5, 2022
(86) PCT No.: PCT/JP2022/044799

§ 371 Date: Jun. 24, 2024

(30) Foreign Application Priority Data
Dec. 24, 2021 (JP) 2021-211716

(51) Int. Cl. H01Q 1/32; H01Q 1/48; H01Q 9/04

(52) U.S. Cl. CPC H01Q 1/3291; H01Q 1/48; H01Q 9/0407

(57) ABSTRACT

Provided are a patch antenna and an antenna device that are capable of maintaining unidirectionality even if the area size of a ground conductor facing a patch element is restricted. A patch antenna includes: a patch element of a conductor plate; and a ground conductor that includes a ground conductor substrate, which serves as a conductor base part facing the patch element, and includes conductor metal extension parts. The conductor metal extension parts are electrically connected to ends of the ground conductor substrate and are arranged so as to be perpendicular or inclined to a plane formed by the ground conductor substrate.

### TECHNICAL FIELD

The present invention relates to a patch antenna including a patch element as an element for transmitting and receiving radio waves, and an antenna device including the patch antenna.

### BACKGROUND ART

A patch antenna using a patch element which is a radiation element is widely known as a small and thin unidirectional antenna, and is used for various applications such as satellite communication. In general, the patch antenna is an antenna that is orthogonal to a radiation surface of the patch element and has radiation directivity in a direction opposite to a facing ground conductor direction. This unidirectional directivity is based on the premise that the ground conductor has a sufficiently large area compared to the patch element.

When the patch element that radiates linear polarization is square or circular, a standing wave current is generated in a longitudinal direction on the radiation surface of the patch element, for example, in a linear direction connecting a feed point and a center of the patch element, and a high electric field region is generated in a gap between an end portion of the patch element and the ground conductor in a current direction. When a dimension of the ground conductor in the current direction is a half wavelength of an operating frequency similarly to the patch element at the time of generation of the high electric field region, current distribution of the ground conductor is equal to that of the patch element, and therefore, the radio wave is also radiated in a direction opposite to a radiation direction of the radio wave of the patch element. In other words, the patch antenna requires a sufficiently wide area of the ground conductor with respect to the patch element in order to implement original unidirectional directivity due to an operation principle.

However, there are many cases in which it is difficult to secure the size of the ground conductor for the convenience of implementation in accordance with an application. When the dimension of the ground conductor in a resonance direction of the patch element is shortened to a half wavelength of a resonance frequency, a radiation pattern changes from the unidirectional directivity to bidirectional directivity. A method of loading a parasitic patch element is general as a method for maintaining the unidirectional directivity, and a region for loading a parasitic element is necessary.

The present applicant has proposed Patent Literature 1 as an antenna device using a patch element.

### CITATION LIST

### Patent Literature

Patent Literature 1: Japanese Patent No. 6422547

### SUMMARY OF INVENTION

### Technical Problem

As described above, when the size of the ground conductor is reduced for the convenience of the implementation, the radiation pattern changes from the unidirectional directivity to the bidirectional directivity, and therefore, when the unidirectional directivity is intended, directional characteristics deteriorate, which is not preferable. When a parasitic patch element is loaded, a region for loading the parasitic patch element is necessary.

An object of the present invention is to improve unidirectional directivity.

### Solution to Problem

A first aspect of the present invention is a patch antenna. The patch antenna includes
a patch element of a conductor plate, and
a ground conductor including a conductor base portion facing the patch element and a conductor extension portion or a dielectric extension portion.

The conductor extension portion may be electrically connected to an end portion of the conductor base portion, and may be provided perpendicularly or obliquely with respect to a plane formed by the conductor base portion.

The conductor extension portion may be provided perpendicularly or obliquely to a side opposite to the patch element with respect to a plane formed by the conductor base portion.

The dielectric extension portion may be provided at one or both of the conductor base portion and the conductor extension portion.

A dielectric spacer may be interposed between the patch element and the conductor base portion, the dielectric spacer may have a facing area smaller than the patch element and the conductor base portion, and a space between the patch element and the conductor base portion where the dielectric spacer is absent may be hollow.

The dielectric spacer may be disposed at a position separated from an end portion in a resonance direction of the patch element.

A center conductor of a coaxial cable may be connected to the patch element, and an outer conductor of the coaxial cable may be connected to the ground conductor.

A second aspect of the present invention is an antenna device. In the antenna device, the patch antenna is housed in a case including a radio wave transmissive portion.

The patch antenna may be supported by a vehicle body such that main polarization of the patch antenna is vertical polarization.

The case has a combined structure of a first case portion and a second case portion, and the conductor extension portion or the dielectric extension portion is sandwiched between the first case portion and the second case portion.

Any combination of the above components and conversion of the expression of the present invention between methods and systems are also effective as aspects of the present invention.

According to an aspect of the present invention, in a configuration including a patch element and a ground conductor facing the patch element, it is possible to implement good unidirectional directivity and to implement miniaturization of an antenna device.

### BRIEF DESCRIPTION OF DRAWINGS

FIG. 1 is an exploded perspective view of a patch antenna and an antenna device according to a first embodiment of the present invention as viewed from the front of a case of the antenna device.

FIG. 2 is an exploded perspective view of the antenna device according to the first embodiment as viewed from the rear of the case.

FIG. 3A is a perspective view of the antenna device according to the first embodiment as viewed from the front of the case.

FIG. 3B is a perspective view in which the antenna device according to the first embodiment is disposed inside a windshield of a vehicle body.

FIG. 4 is a side cross-sectional view of the antenna device according to the first embodiment.

FIG. 5 is a front view of the patch antenna according to the first embodiment.

FIG. 6 is a side view of the patch antenna according to the first embodiment.

FIG. 7 is a plan view of the patch antenna according to the first embodiment.

FIG. 8 is a diagram of directional characteristics in a horizontal plane of the patch antenna according to the first embodiment.

FIG. 9A is a perspective view of a patch antenna including a patch element and a ground conductor substrate having a planar shape and without a conductor metal extension portion.

FIG. 9B is a perspective view of a patch antenna in which a conductor metal extension portion is added to the ground conductor substrate (base portion) having a planar shape.

FIG. 9C is a diagram of directional characteristics in a horizontal plane indicating a case of FIG. 9A with a dotted line and a case of FIG. 9B with a solid line.

FIG. 10A is a side view of the patch antenna according to the first embodiment in which the conductor metal extension portion is added to the ground conductor substrate (base portion) having a planar shape and the patch element is faced via a dielectric spacer, when the dielectric spacer is located at a position of an intermediate point between end portions in a resonance direction of the patch element.

FIG. 10B is a side view of the patch antenna in which the conductor metal extension portion is added to the ground conductor substrate (base portion) having a planar shape and the patch element is faced via a dielectric spacer, when the dielectric spacer is disposed at an end portion in the resonance direction of the patch element.

FIG. 10C is a diagram of directional characteristics in a horizontal plane indicating a case of FIG. 10A with a solid line and a case of FIG. 10B with a dotted line.

FIG. 11A is a side view of the patch antenna in which the conductor metal extension portion is added to the ground conductor substrate (base portion) having a planar shape and the patch element is faced via a dielectric spacer, when the dielectric spacer is located at a position of an intermediate point between end portions in the resonance direction of the patch element, that is, offset by 0 mm from the intermediate point.

FIG. 11B is a side view when the dielectric spacer is disposed at a position offset by 8 mm from the intermediate point between the end portions in the resonance direction of the patch element.

FIG. 11C is a graph illustrating a relation between a spacer offset position (mm) and an average gain [dBi] in a horizontal plane.

FIG. 12 is a side cross-sectional view of an antenna device according to a second embodiment.

FIG. 13A is a perspective view of a patch antenna including a patch element and a ground conductor substrate having a planar shape and without a dielectric extension portion.

FIG. 13B is a perspective view of a patch antenna in which a dielectric extension portion is provided at a ground conductor substrate having a planar shape.

FIG. 13C is a diagram of directional characteristics in a horizontal plane indicating a case of FIG. 13A with a dotted line and a case of FIG. 13B with a solid line.

FIG. 14 is a side view of an upper half of an antenna device illustrating a modification of the present invention.

### DESCRIPTION OF EMBODIMENTS

Hereinafter, preferred embodiments of the present invention will be described in detail with reference to the drawings. The same or equivalent components, members, processes, and the like illustrated in the drawings are denoted by the same reference numerals, and redundant description thereof will be omitted as appropriate. The embodiments are not intended to limit the invention but are mere exemplifications, and all features and combinations thereof described in the embodiments are not necessarily essential features of the invention.

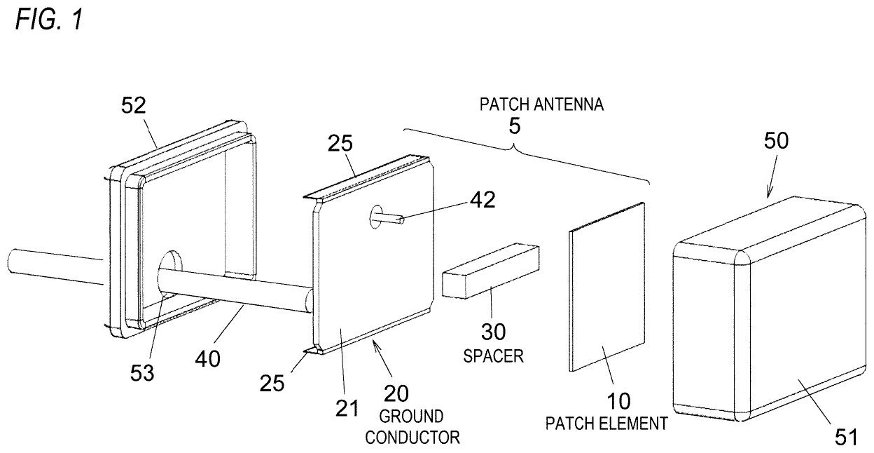

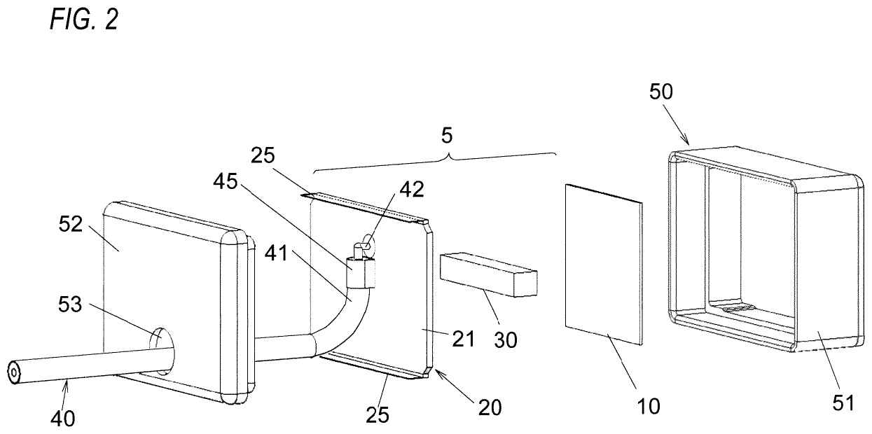

An antenna device 1 according to a first embodiment will be described with reference to FIGS. 1 to 8. First, a configuration of the antenna device 1 according to the first embodiment will be described with reference to FIGS. 1 and 2. The antenna device 1 includes a patch antenna 5, a spacer 30 which is a dielectric, a coaxial cable 40 serving as a feed line, and a case 50 which is radio wave transmissive and is made of a resin.

The patch antenna 5 includes a patch element 10 which is a conductor metal plate as a radiation element, and a ground conductor 20 facing the patch element 10 at a predetermined interval. The ground conductor 20 faces the patch element 10 via the spacer 30 at a predetermined interval. In the first embodiment, it is assumed that the patch antenna 5 is an antenna for vertical polarization. The patch element 10 has an electrical length equivalent to about ½ wavelength of an operating frequency. A shape of the patch element 10 is not limited to a rectangle illustrated in FIGS. 1 and 2, and may be a circle or the like.

The ground conductor 20 includes a ground conductor substrate 21 as a base portion of the ground conductor 20 facing the patch element 10 in parallel, and conductor metal extension portions 25 provided at end portions of the ground conductor substrate 21. The ground conductor substrate 21 has, for example, double-sided conductor metal films electrically connected to each other, and the conductor metal extension portions 25 are provided at the end portions of the ground conductor substrate 21 (specifically, both sides of ground conductor substrate 21 along resonance direction of patch element 10). The conductor metal extension portions 25 are electrically connected to the conductor metal films of the ground conductor substrate 21. The conductor metal extension portions 25 are fixed to the end portions of the ground conductor substrate 21 as separate components, or is formed integrally with the ground conductor substrate 21. The conductor metal film of the ground conductor substrate 21 may exist on at least a side facing the patch element 10. An area of the conductor metal film of the ground conductor substrate 21 facing the patch element 10 is larger than an area of the facing patch element 10. A dimension of the conductor metal film of the ground conductor substrate 21 as viewed in the resonance direction of the patch element 10 is set longer than that of the patch element 10. The conductor metal extension portions 25 each have a plate shape and extend from the end portions of the ground conductor substrate 21 in a direction opposite to a side at which the patch element 10 is disposed. In the illustrated case, the conductor metal extension portions 25 are provided perpendicularly with respect to the ground conductor substrate 21. Cases other than that illustrated in the drawings will be described as modifications to be described later. A case where the conductor metal extension portions 25 are provided at both sides of the ground conductor substrate 21 along the resonance direction of the patch element 10 is illustrated. However, the conductor metal extension portion 25 may be provided on three sides or four sides of the ground conductor substrate 21. The ground conductor substrate 21 may be a substrate made of a conductor metal plate itself instead of a double-sided conductor substrate.

The spacer 30 is an insulating dielectric such as ABS resin, and has, for example, a prismatic shape. Due to a thickness thereof, the spacer 30 keeps the patch element 10 and the ground conductor substrate 21 apart from each other at a predetermined interval, and integrally holds the patch element 10 and the ground conductor substrate 21 in a parallel or substantially parallel state. The spacer 30 integrally holds the patch element 10 and the ground conductor substrate 21 by using an adhesive member together as necessary. A space between the patch element 10 and the ground conductor substrate 21 where the spacer 30 is absent is hollow. An area of a contact surface of the spacer 30 in contact with the patch element 10 and the ground conductor substrate 21 is set sufficiently smaller than the areas of the patch element 10 and the ground conductor substrate 21 in order to reduce a dielectric loss caused by the spacer 30.

An outer conductor 41 of the coaxial cable 40 serving as a feed line is electrically connected to the conductor metal film of the ground conductor substrate 21 via a holding fitting 45 (see FIG. 2). A center conductor 42 of the coaxial cable 40 penetrates the ground conductor substrate 21. The center conductor 42 of the coaxial cable 40 may penetrate the conductor metal film of the ground conductor substrate 21 in a non-contact manner. The center conductor 42 penetrating the ground conductor substrate 21 is electrically connected to the patch element 10 at a feed point 11 to be described later. In the first embodiment, as illustrated in FIG. 2, the outer conductor 41 of the coaxial cable 40 is electrically connected to the ground conductor substrate 21 on a side opposite to a patch element 10 side. The center conductor 42 of the coaxial cable 41 is exposed to the patch element 10 side of the ground conductor substrate 21 through a through hole provided in the ground conductor substrate 21. The exposed center conductor 42 is electrically connected to the patch element 10.

The case 50 made of a resin includes a front-side case portion (first case portion) 51 and a back-side case portion (second case portion) 52. The front-side case portion 51 and the back-side case portion 52 have, for example, a structure in which the front-side case portion 51 and the back-side case portion 52 are fitted to each other, and by fitting the front-side case portion 51 and the back-side case portion 52 to each other, an internal space for accommodating the patch antenna 5 and the like is formed. The front-side case portion 51 including at least a portion facing the patch element 10 has radio wave transparency. The coaxial cable 40 is drawn into the internal space of the case 50 through a through hole 53 of the back-side case portion 52.

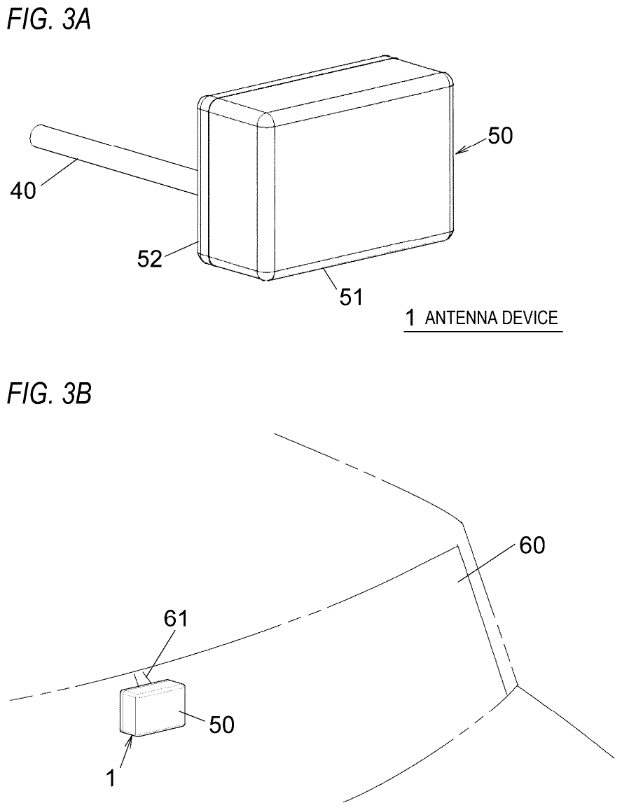

As illustrated in FIG. 3A, the patch antenna 5 and a part of the coaxial cable 40 drawn through the through hole 53 (see FIG. 2) provided in the back-side case portion 52 are accommodated in the internal space formed by fitting the front-side case portion 51 and the back-side case portion 52 of the antenna device 1.

For example, as illustrated in FIG. 3B, the antenna device 1 illustrated in FIG. 3A is held at an upper portion inside a windshield 60 of a vehicle body by a support member 61. The antenna device 1 functions as a vehicle-mounted antenna device. The antenna device 1 illustrated in FIG. 3B is held by a vehicle body such that the radiation directivity of the patch element 10 of the patch antenna 5 accommodated in the case 50 made of a resin is in a forward direction (traveling direction) of the vehicle body.

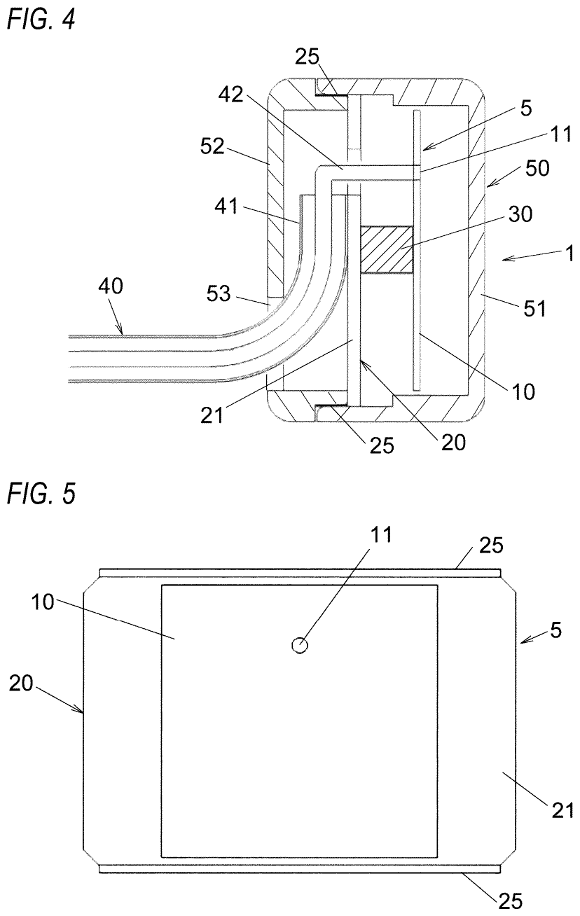

Next, the patch antenna 5 accommodated in the internal space of the case 50 made of a resin of the antenna device 1 will be described with reference to FIG. 4.

In the patch antenna 5 accommodated in the internal space of the case 50 made of a resin, the patch element 10 is disposed with a gap from the front-side case portion 51. The patch element 10 is connected to the spacer 30 at a substantially intermediate position on a side opposite to the front-side case portion 51 side. The ground conductor substrate 21 is connected to the spacer 30 at a substantially intermediate position on the patch element 10 side. In this manner, the spacer 30 is held at a substantially intermediate position between the patch element 10 and the ground conductor substrate 21 with a predetermined interval therebetween.

The outer conductor 41 of the coaxial cable 40 drawn into the internal space of the case 50 through the through hole 53 of the back-side case portion 52 is electrically connected at a position where a height (in FIGS. 4 and 5, height direction is vertical direction of paper surface) from a bottom surface of the case 50 illustrated in FIG. 4 on a side opposite to a spacer 30 side of the ground conductor substrate 21 is substantially the same as a height of the spacer 30. The center conductor 42 of the coaxial cable 40 is exposed to the patch element 10 side from the through hole above the ground conductor substrate 42 illustrated in FIG. 4 and is electrically connected to the feed point 11 of the patch element 10.

As illustrated in FIG. 4, the conductor metal extension portions 25 provided at two ends of the ground conductor substrate 21 so as to be perpendicular to the ground conductor substrate 21 are sandwiched between the front-side case portion 51 and the back-side case portion 52 at fitting portions (engaging portions or joining portions) of the two cases. For example, the patch antenna 5 may be held with respect to the case 50 by sandwiching the conductor metal extension portions 25 between the front-side case portion 51 and the back-side case portion 52 at the fitting portions of the two cases.

FIG. 5 is a front view of the patch antenna 5 as viewed from a front side. As illustrated in FIG. 5, the center conductor 42 of the coaxial cable 40 is electrically connected to the feed point 11 provided at an upper portion of the patch element 10. When electricity is supplied to the feed point via the coaxial cable 40, radio waves are radiated from the patch element 10.

As illustrated in FIG. 5, regarding sizes of the patch element 10 and the ground conductor substrate 21, the size of the patch element 10 in a width direction (lateral direction of paper surface) is smaller than the size of the ground conductor substrate 21, and the sizes in a vertical direction (vertical direction of paper surface) are substantially the same, as viewed from the front (from front side of paper surface in FIG. 5). The patch element 10 is disposed substantially at the center of the ground conductor substrate 21. The conductor metal extension portions 25 provided at two ends of the ground conductor substrate 21 are provided in the vertical direction (vertical direction of paper surface) having substantially the same size in an arrangement relation with the patch element 10.

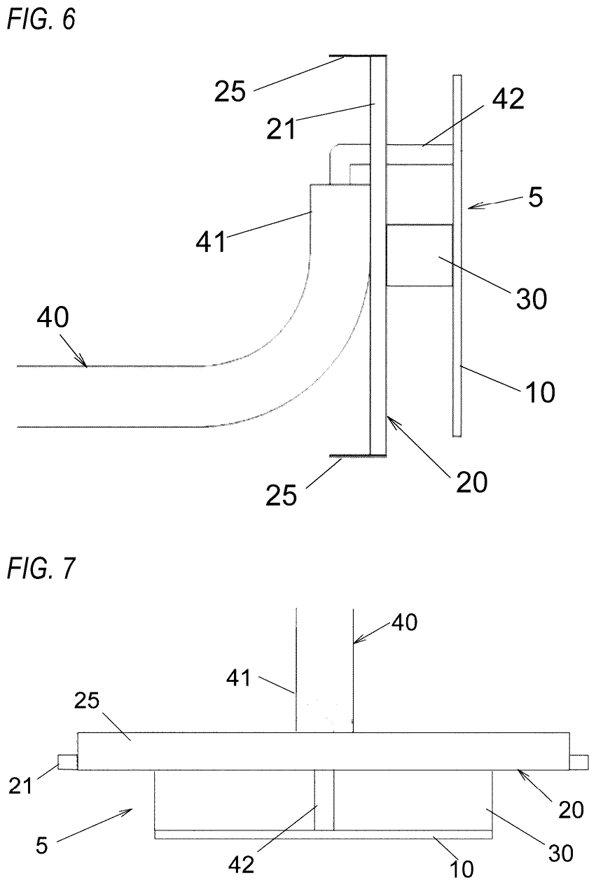

As illustrated in FIG. 6, the conductor metal extension portions 25 are provided at two ends of the ground conductor substrate 21 in the vertical direction having substantially the same size as the patch element 10 so as to extend to the side opposite to the patch element 10.

As illustrated in FIGS. 5 and 7, the conductor metal extension portions 25 are provided so as to extend over substantially the entire length of the ground conductor substrate 21 (ground conductor 20) in the width direction (lateral direction of paper surface) illustrated in FIG. 5.

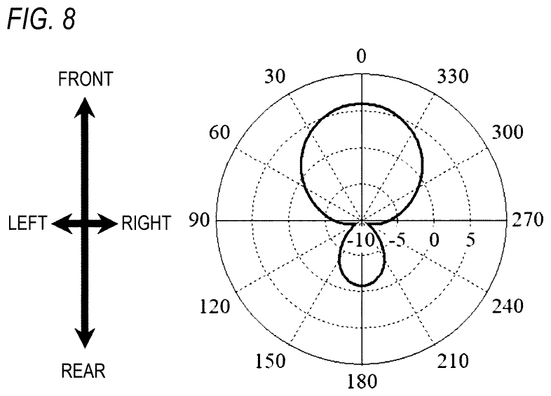

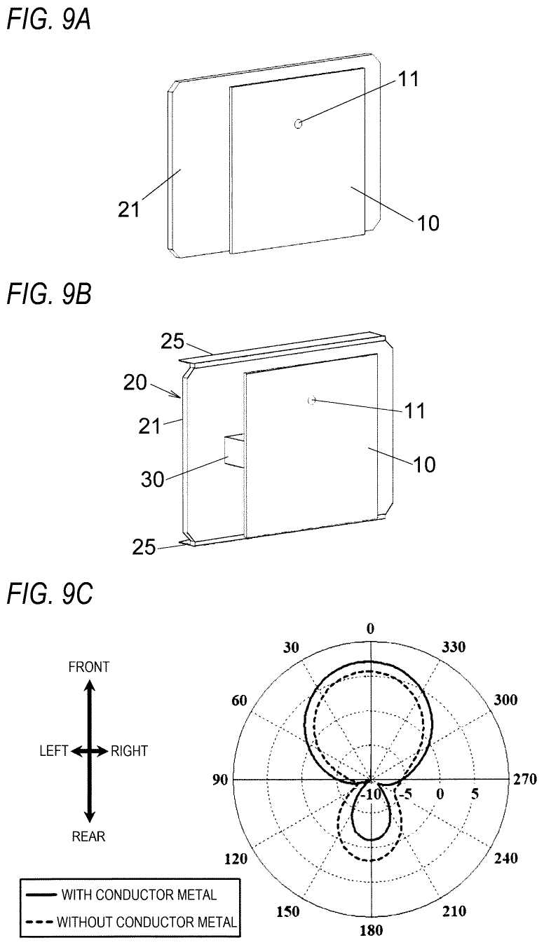

FIG. 8 is a diagram of directional characteristics in a horizontal plane of the antenna device 1 according to the first embodiment when the patch element 10 is fed with power from the coaxial cable 40 and a vertically polarized radio wave is radiated from the patch element 10. As is apparent from the directional characteristics in a horizontal plane of FIG. 8, good unidirectional directivity can be implemented without increasing the area of the ground conductor substrate 21 serving as the base portion of the ground conductor. A reason will be described with reference to FIGS. 9A to 9C, 10A to 10C, and 11A to 11C.

Operation and effect obtained by adding the conductor metal extension portions 25 will be described with reference to FIGS. 9A to 9C. FIG. 9A is a perspective view of a patch antenna including the patch element 10 and the ground conductor substrate 21 having a planar shape and without a conductor metal extension portion, and FIG. 9B is a perspective view of a patch antenna in which the patch element 10 and the ground conductor 20 provided with the conductor metal extension portions 25 on the ground conductor substrate 21 (base portion) having a planar shape are faced to each other via the spacer 30. Even when the area of the ground conductor substrate 21 having a planar shape and facing the patch element 10 in parallel on the front side is the same in FIGS. 9A and 9B, the directional characteristics in a horizontal plane are improved by extending the conductor metal extension portions 25 from both end portions of the ground conductor substrate 21 having a planar shape in a direction opposite to a side where the patch element 10 is disposed in the case of FIG. 9B, as can be seen from the diagram of directional characteristics in a horizontal plane in FIG. 9C. That is, a gain of the patch element 10 in the forward direction increases, a gain of the patch element 10 in a rearward direction (direction toward ground conductor 20 side) decreases, and the unidirectional directivity is improved. A reason is that by providing the conductor metal extension portions 25 at the end portions in the current direction of the ground conductor substrate 21 having a planar shape in the configuration of FIG. 9B, an electrical path length of the ground conductor 20 in the current direction of the patch element 10 is extended to be sufficiently larger than a half wavelength of the operating frequency, and accordingly, the current distribution of the patch element may vary, radiation from the ground conductor 20 may be suppressed, and the unidirectional directivity may be improved.

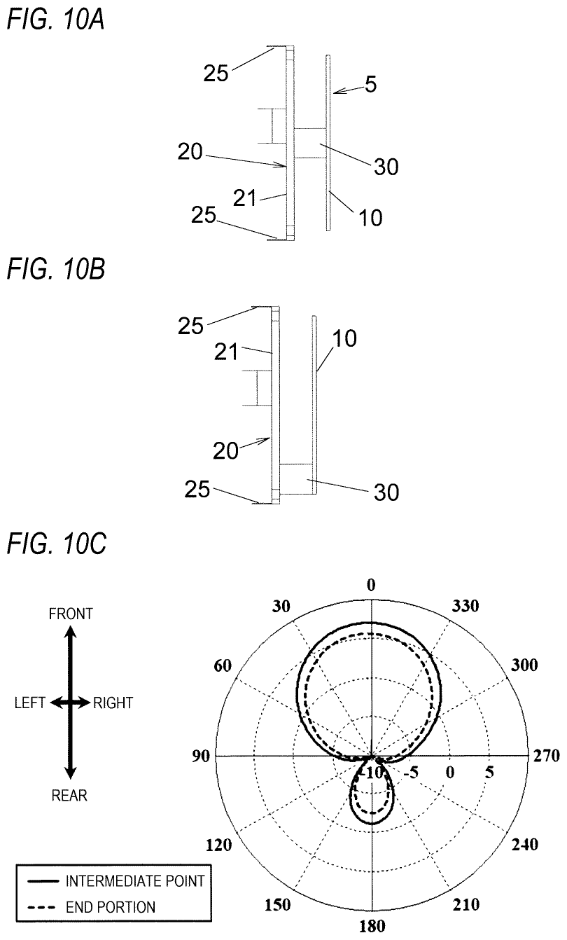

In FIGS. 10A to 10C, a change in directional characteristics depending on the position of the spacer 30 of the dielectric will be considered. FIG. 10A is a side view of the patch antenna 5 according to the first embodiment in which the conductor metal extension portions 25 are provided on the ground conductor substrate 21 serving as a ground conductor (base portion) having a planar shape and the patch element 10 is faced via the spacer 30, when the spacer 30 is located at a substantially intermediate position between two end portions in the resonance direction of the patch element 10, and FIG. 10B is a side view of the similar patch antenna when the spacer 30 is disposed at an end portion in the resonance direction of the patch element 10, in other words, an end portion in the current direction. When the main polarization is vertical polarization, the end portion in the resonance direction of the patch element 10 is the end portion in an upper-lower direction of the illustrated patch element 10. As illustrated in the diagram of directional characteristics in a horizontal plane in FIG. 10C, the directional characteristics in a horizontal plane are improved in FIG. 10A in which the spacer 30 is located at a substantially intermediate position between the two end portions in the resonance direction of the patch element 10, compared to the configuration of FIG. 10B in which the spacer 30 is located at the end portion in the resonance direction of the patch element 10. That is, by reducing the dielectric loss, the gain in all directions in the horizontal plane is improved, and the unidirectional directivity is improved. A reason is that, in the configuration of FIG. 10B, the spacer 30 is located at the end portion in the resonance direction of the patch element 10 having a large electric field strength, and thus the dielectric loss caused by the spacer 30 becomes large. whereas in the configuration of FIG. 10A, the spacer 30 is located at a substantially intermediate position between the two end portions in the resonance direction of the patch element 10 having a minimum electric field strength, and thus the dielectric loss caused by the spacer 30 becomes small.

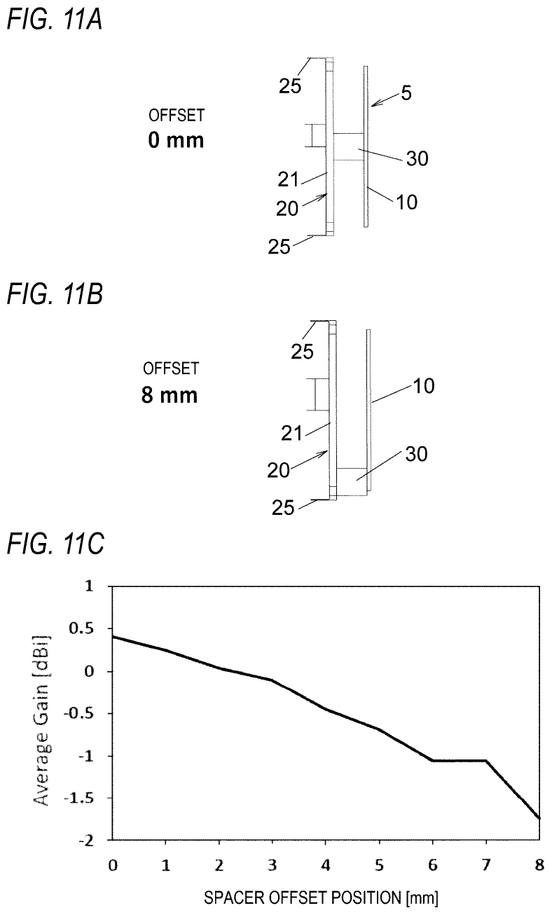

In FIGS. 11A to 11C, a change in the average gain [dBi] in the forward direction of the patch element 10 depending on the position of the spacer 30 will be considered. FIGS. 11A 30) and 11B illustrate the patch antenna 5 in which the conductor metal extension portions 25 are provided at the ground conductor substrate 21 (base portion) and the patch element 10 is faced via the spacer 30. FIG. 11A is a side view when the spacer 30 is located at a substantially intermediate position between the two end portions in the resonance direction of the patch element 10, that is, at a position with an offset amount of 0 mm from the intermediate position, and FIG. 11B is a side view when the spacer 30 is disposed at a position with an offset amount of 8 mm from the substantially intermediate position between the end portions in the resonance direction of the patch element. As can be seen from FIG. 11C, the average gain decreases as the offset amount of the position of the spacer 30 increases from 0 mm. That is, it is understood that the dielectric loss caused by the spacer 30 is minimized at a spacer position where the position of the spacer 30 is offset by 0 mm.

As a result, in the antenna device 1 according to the first embodiment, the directional characteristics when the patch element 10 is fed with power from the coaxial cable 40 and the vertically polarized radio wave is radiated from the patch element 10 are as illustrated in the diagram of the directional characteristics of FIG. 8, and good unidirectional directivity can be implemented without increasing the area of the ground conductor substrate 21 serving as the base portion of the ground conductor.

When the antenna device 1 is mounted on an automatic vehicle, for example, as illustrated in FIG. 3B, the antenna device 1 is held at an upper portion inside the windshield 60 of a vehicle body by the support member 61. At this time, the resonance direction having an electrical length equivalent to about ½ wavelength of the operating frequency of the patch element 10 is a vertical direction perpendicular to the horizontal plane. Accordingly, the main polarization of the patch antenna 5 included in the antenna device 1 becomes vertical polarization, and a predetermined high-frequency power is supplied from the coaxial cable 40 to the patch element 10, so that the vertically polarized radio wave can be radiated substantially in a single direction (in forward direction of patch element 10).

In the case of the antenna device 1 used for vehicle to everything (V2X) communication, the operating frequency of the patch antenna 5 is set to about 5.9 GHz. In this case, an inner dimension of the case 50 made of a resin in the upper-lower direction is about 20 mm, and an interval between the patch element 10 and the ground conductor substrate 21 is several mm or less.

According to the present embodiment, the following effects can be exerted.

(1) In the patch antenna 5, the ground conductor 20 includes the ground conductor substrate 21 serving as a conductor base portion facing the patch element 10 which is a conductor plate, and the conductor metal extension portions 25 electrically connected to end portions and extending to a side opposite to a patch element 10 side, and therefore, an electrical length of the ground conductor 20 can be increased without increasing an area of the conductor base portion parallel to the patch element 10, which has the same effect as increasing the area of the conductor base portion. As a result, the radiation in a ground conductor direction can be suppressed, the gain in the forward direction of the patch element can be increased, and the directivity can be improved. By making the area of the conductor base portion parallel to the patch element 10 smaller than that of a patch antenna in the related art, it is possible to implement miniaturization in a plane parallel to the patch element 10.

(2) In a case where the conductor metal extension portion 25 is provided, on a side opposite to the patch element 10, perpendicularly with respect to a plane formed by the ground conductor substrate 21 serving as the conductor base portion, the end portion of the patch element 10 having a strong electric field and the conductor metal extension portion 25 are sufficiently separated from each other, and therefore, the influence on the patch element 10 due to provision of the conductor metal extension portion 25 can be ignored.

(3) The spacer 30 of the dielectric interposed between the patch element 10 and the ground conductor substrate 21 to integrate the patch element 10 and the ground conductor substrate 21 has a facing area smaller than that of the patch element 10 and the ground conductor substrate 21, and the spacer 30 is disposed at a position separated from the end portion in the resonance direction serving as a strong electric field of the patch element 10, and therefore, it is possible to reduce the dielectric loss caused by disposing the spacer 30.

(4) The patch antenna 5 is housed in the case 50 including a radio wave transmissive

portion, and the case 50 is supported on an inner side of a windshield of a vehicle body such that the patch antenna 5 is for vertical polarization, whereby the patch antenna 5 can be suitably used as an antenna device for vehicle to everything communication in which the case is miniaturized in the upper-lower direction.

(5) The case 50 has a combined structure of the front-side case portion (first case portion) 51 and the back-side case portion (second case portion), and the conductor metal extension portion 25 having an integral structure with the ground conductor substrate 21 is sandwiched between the front-side case portion 51 and the back-side case portion 52, whereby the patch antenna 5 can be held in the case 50, and the structure can be simplified.

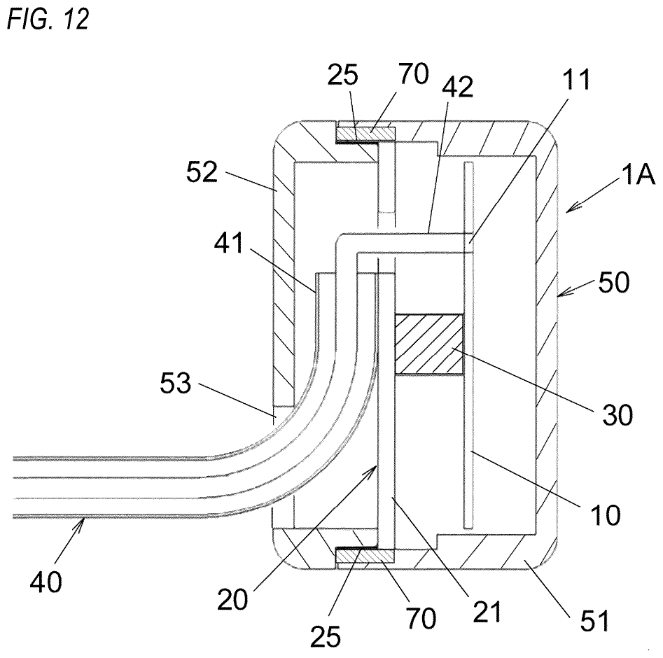

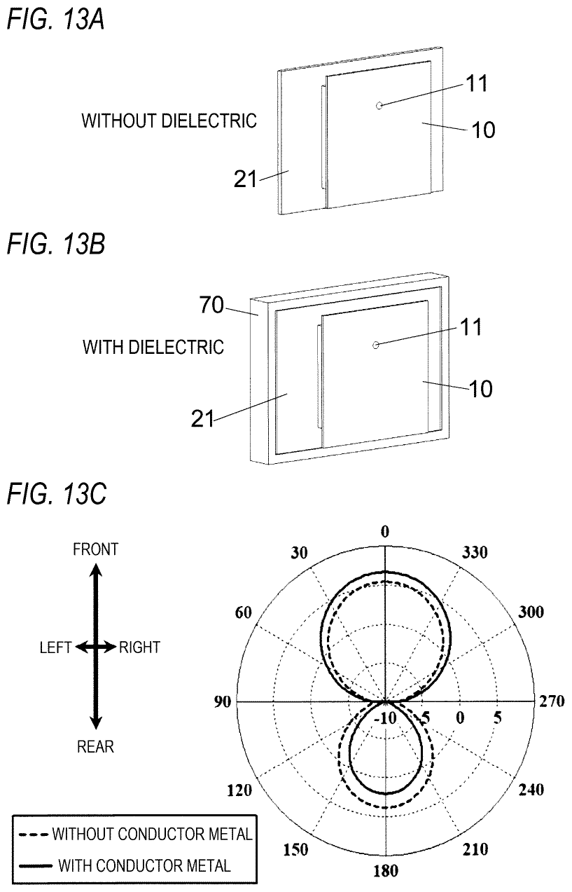

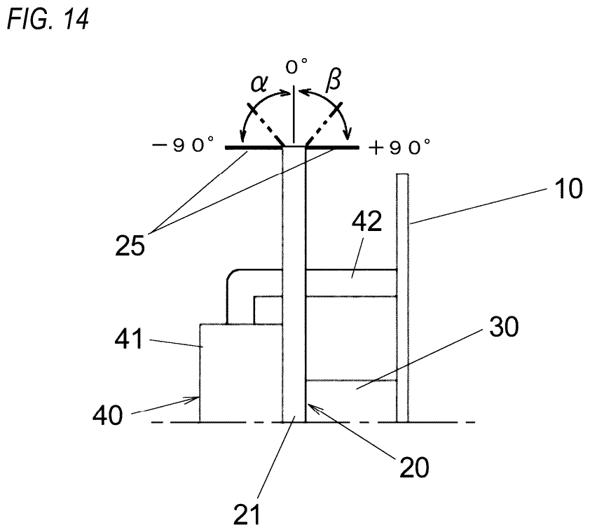

A second embodiment of the present invention will be described with reference to FIGS. 12, 13A, 13B, and 13C. In an antenna device 1A according to the second embodiment, dielectric extension portions 70 are provided at the ground conductor 20 in addition to the configuration of the first embodiment. Specifically, the dielectric extension portion 70 is provided as a conductor base portion across the ground conductor substrate 21 and the conductor metal extension portion 25. The dielectric extension portion 70 is preferably made of a dielectric material having a dielectric constant sufficiently larger than that of the case 50 made of a resin. Other configurations are the same as those of the first embodiment. The dielectric extension portion 70 may be disposed at the ground conductor substrate 21 outside or inside the conductor metal extension portion 25.

Operation and effect obtained by adding the dielectric extension portion 70 will be described with reference to FIGS. 13A to 13C. FIG. 13A is a perspective view of a basic patch antenna including the patch element 10 and the ground conductor substrate 21 (without dielectric extension portion) having a planar shape, and FIG. 13B is a perspective view of a patch antenna in which the dielectric extension portion 70 is added to the ground conductor substrate 21 (base portion) having a planar shape. Even when the area of the ground conductor substrate 21 having a planar shape, which faces the patch element 10 in parallel on the front side, is the same in FIGS. 13A and 13B, the directional characteristics in a horizontal plane are improved by providing the dielectric extension portion 70 so as to surround the end portion of the ground conductor substrate 21 having a planar shape in the case of FIG. 13B, as can be seen from the diagram of directional characteristics in a horizontal plane of FIG. 13C. As a result, in the antenna device 1A according to the second embodiment, the gain in the forward direction toward the patch element 10 increases, the gain in the rearward direction toward the ground conductor 20 side decreases, and the unidirectional directivity is favorably maintained. A reason is that by providing the dielectric extension portions 70 at the end portions in the current direction of the ground conductor substrate 21 having a planar shape in the configuration of FIG. 13B, an electrical path length of the ground conductor substrate 21 in the current direction of the patch element 10 is extended to be sufficiently larger than a half wavelength of the operating frequency. According to this effect, in the antenna device 1A, the current distribution of the patch element 10 may vary, radiation from the ground conductor 20 may be suppressed. and the unidirectional directivity may be improved.

Although the present invention has been described with reference to the embodiments, it is to be understood by those skilled in the art that various modifications can be made to the components and the processes of the embodiments within the scope of the claims. Hereinafter, modifications will be described.

In the first embodiment, a configuration in which the conductor metal extension portions 25 extend perpendicularly to a surface of the ground conductor substrate 21 from end portions of the ground conductor substrate 21 to a side opposite to a patch element side is illustrated, but an inclination angle of the conductor metal extension portions 25 with respect to the ground conductor substrate 21 is not limited to perpendicular (except posture parallel to ground conductor substrate 21). In FIG. 14, when the inclination angle of the conductor metal extension portion 25 with respect to the ground conductor substrate 21 in a case of being perpendicular to the surface of the ground conductor substrate 21 on the side opposite to the patch element side is defined as −90°, the inclination angle in a case of being parallel to the surface of the ground conductor substrate 21 is defined as 0°, and the inclination angle of the conductor metal extension portion 25 with respect to the ground conductor substrate 21 in a case of being perpendicular to the surface of the ground conductor substrate 21 on the patch element side is defined as +90°, an inclination angle range α (−90°≤α<0°) or an inclination angle range β (0°<β≤+90°) in FIG. 14 may be set. However, it is preferable that the inclination angle range α has less influence on the patch element 10.

In the second embodiment, a configuration in which the conductor metal extension portions 25 and the dielectric extension portions 70 are added to end portions of the ground conductor substrate 21 is illustrated, but the conductor metal extension portion 25 may be omitted, and the dielectric extension portion 70 may be disposed at the end portion of the ground conductor substrate 21 as illustrated in FIG. 13B. The dielectric extension portion 70 is preferably disposed to be separated from the end portion in the resonance direction of the patch element 10 in order to reduce dielectric loss.

Instead of forming the ground conductor 20 by the ground conductor substrate 21 serving as the base portion and the conductor metal extension portion 25 provided at the end portion of the ground conductor substrate 21, the base portion and the extension portion bent with respect to the base portion may be integrally formed of a metal plate of conductor metal. A shape of the ground conductor 20 is not limited to a rectangular shape, and may be any shape as long as an area facing the patch element is larger than the patch element.

### REFERENCE SIGNS LIST

1, 1A: antenna device
5: patch antenna
10: patch element
20: ground conductor
21: ground conductor substrate
25: conductor metal extension portion
30: spacer
40: coaxial cable
50: case
51: front-side case portion
52: back-side case portion
60: windshield
61: support member
70: dielectric extension portion

1. A patch antenna comprising:
a patch element of a conductor plate; and
a ground conductor including a conductor base portion facing the patch element and a conductor extension portion or a dielectric extension portion.

2. The patch antenna according to claim 1, wherein
the conductor extension portion is electrically connected to an end portion of the conductor base portion, and is provided perpendicularly or obliquely with respect to a plane formed by the conductor base portion.

3. The patch antenna according to claim 2, wherein
the conductor extension portion is provided perpendicularly or obliquely to a side opposite to the patch element with respect to a plane formed by the conductor base portion.

4. The patch antenna according to claim 1, wherein
the dielectric extension portion is provided at one or both of the conductor base portion and the conductor extension portion.

5. The patch antenna according to claim 1, wherein
a dielectric spacer is interposed between the patch element and the conductor base portion, the dielectric spacer has a facing area smaller than the patch element and the conductor base portion, and a space between the patch element and the conductor base portion where the dielectric spacer is absent is hollow.

6. The patch antenna according to claim 1, wherein
the dielectric spacer is disposed at a position separated from an end portion in a resonance direction of the patch element.

7. The patch antenna according to claim 1, wherein
a center conductor of a coaxial cable is connected to the patch element, and an outer conductor of the coaxial cable is connected to the ground conductor.

8. An antenna device comprising the patch antenna according to claim 1 housed in a case including a radio wave transmissive portion.

9. The antenna device according to claim 8, wherein
the patch antenna is supported by a vehicle body such that main polarization of the patch antenna is for vertical polarization.

10. The antenna device according to claim 8, wherein
the case has a combined structure of a first case portion and a second case portion, and the conductor extension portion or the dielectric extension portion is sandwiched between the first case portion and the second case portion.
